(19) United States
(12) Patent Application Publication
(10) Pub. No.: US 2026/0135133 A1
(43) Pub. Date: May 14, 2026

(54) BATTERY ELECTRODE PLATE STACKING APPARATUS FOR ENGAGING WITH AUTOMATIC LOGISTICS TRANSPORT DEVICE

(71) Applicant: SK On Co., Ltd., Seoul (KR)

(72) Inventors: Dong Hee JEONG, Daejeon (KR); Chi Hyun KIM, Daejeon (KR)

(21) Appl. No.: 19/352,618

(22) Filed: Oct. 8, 2025

(30) Foreign Application Priority Data
Nov. 8, 2024 (KR) 10-2024-0158177

(51) Int. Cl. H01M 10/04

(52) U.S. Cl. CPC H01M 10/0404

(57) ABSTRACT

A battery electrode plate stacking apparatus for engaging with an automatic logistics transport device includes an entry/exit port configured through which a plurality of electrode plate sets sequentially transported by a transporter of a logistics transport device are disposed, a transport unit configured to transport an electrode plate set disposed at the entry/exit port, and a stacking unit configured to use a plurality of electrode plates included in the electrode plate set transported by the transport unit in a stacking process. The transport unit includes a first buffer on which a next-order electrode plate set waits when a plurality of electrode plates of an electrode plate set priorly transported to the stacking unit among the plurality of electrode plate sets are being used in the stacking process.

### CROSS-REFERENCE TO RELATED APPLICATION(S)

This patent document claims the priority and benefits of Korean Patent Application No. 10-2024-0158177 filed on Nov. 8, 2024, the disclosure of which is incorporated herein by reference in its entirety.

### TECHNICAL FIELD

The disclosure and implementations disclosed in this patent document generally relate to a battery electrode plate stacking apparatus for engaging with an automatic logistics transport device.

### BACKGROUND

The battery manufacturing process may include an electrode manufacturing process for manufacturing electrode plates, a battery cell assembly process for assembling battery cells including the electrode plates, and a formation process for forming electrical characteristics in the assembled battery cells. The battery cell assembly process may include a stacking process for forming a stack by stacking electrode plates (cathode plates and anode plates) and a separator, and an assembly process for disposing the stack and electrolyte within a battery case.

### SUMMARY

The productivity of a stacking process may be enhanced by increasing the efficiency of supply of electrode plates (cathode plates and anode plates). When using automatic logistics transport device to supply electrode plates (cathode plates and anode plates) to the stacking process, the efficiency of electrode plate supply and the productivity of the stacking process may be improved.

The present disclosure can be implemented in some embodiments to provide a battery electrode plate stacking apparatus for engaging an automatic logistics transport device, in which productivity and/or a safety of a stacking process may be enhanced by stably linking the battery electrode plate stacking apparatus to the automatic logistics transport device.

In some embodiments of the present disclosure, a battery electrode plate stacking apparatus for engaging with an automatic logistics transport device includes an entry/exit port configured through which a plurality of electrode plate sets sequentially transported by a transporter of a logistics transport device are disposed; a transport unit configured to transport an electrode plate set disposed at the entry/exit port; and a stacking unit configured to use a plurality of electrode plates included in the electrode plate set transported by the transport unit in a stacking process. The transport unit includes a first buffer on which a next-order electrode plate set waits when a plurality of electrode plates of an electrode plate set priorly transported to the stacking unit among the plurality of electrode plate sets are being used in the stacking process.

In an example, each of the plurality of electrode plate sets may further include a loading box into which the plurality of electrode plates are loaded, and the transport unit may transport a loading box from which electrode plates have been exhausted by the stacking unit, to the entry/exit port.

In an example, the transport unit may further include a second buffer on which a next loading box waits when the loading box, from which the electrode plates have been exhausted, is disposed at the entry/exit port.

In an example, a transport path of the transport unit may include a U-turn path, and the electrode plate set including the plurality of electrode plates, and the loading box from which the electrode plates have been exhausted, may be disposed in different areas of the entry/exit port.

In an example, the entry/exit port may be provided as a plurality of entry/exit ports, the first buffer may be provided as a plurality of first buffers on which electrode plate sets disposed in the plurality of entry/exit ports, respectively, wait before being transported to the stacking unit, and the second buffer may be provided as a plurality of second buffers on which a plurality of loading boxes from which respective electrode plates have been exhausted wait before being respectively transported to the plurality of entry/exit ports.

In an example, the battery electrode plate stacking apparatus may further include a device controller configured to communicate with the logistics transport device, and the device controller may generate transporter request information based on at least one of an electrode plate set standby status of the first buffer and a loading box standby status of the second buffer, and may transmit the transporter request information to the logistics transport device.

In an example, the entry/exit port may be provided as a plurality of entry/exit ports, and the first buffer may be provided as a plurality of first buffers on which electrode plate sets respectively disposed in the plurality of entry/exit ports wait before being transported to the stacking unit.

In an example, the battery electrode plate stacking apparatus may further include a device controller configured to communicate with the logistics transport device, and the device controller may generate transporter request information based on an electrode plate set standby status of the first buffer and transmits the transporter request information to the logistics transport device.

In an example, the battery electrode plate stacking apparatus may further include a first door configured to selectively block the transporter from entering or exiting the entry/exit port depending on an open/closed state; and a device controller configured to communicate with the logistics transport device. The device controller may receive entry/exit waiting information of the transporter from the logistics transport device, control opening of the first door based on the entry/exit waiting information, transmit opening information of the first door to the logistics transport device, receive farewell waiting information of the transporter from the logistics transport device, and control closing of the first door based on the farewell waiting information.

In an example, the logistics transport device may be configured to sequentially transport the plurality of electrode plate sets using an Overhead Hoist Transport (OHT) method, and the logistics transport device may include a logistics controller and the transporter. The logistics controller may control a logistics transport of the transporter, and the device controller may communicate with the transporter and controls entry/exit of the transporter through the entry/exit port.

In an example, the transport unit may include a placement sensor configured to sense that the plurality of electrode plate sets are disposed at the entry/exit port and to transmit sensing information to the device controller, and the device controller may control a descent stop or an ascent of the transporter based on the sensing information from the placement sensor.

In an example, the battery electrode plate stacking apparatus may further include a second door configured to selectively block manual entry and exit of the plurality of electrode plate sets depending on an open/closed state, and a device controller configured to communicate with the logistics transport device when set to an automatic mode. The device controller may control an interlock of the second door when set to the automatic mode, and control a release of the interlock of the second door when set to a manual mode.

In an example, the device controller may communicate with the logistics transport device to enable the transporter to transport the plurality of electrode plate sets, when set to the automatic mode, and may communicate with the logistics transport device to stop the transporter from transporting the plurality of electrode plate sets, when set to the manual mode.

In an example, the stacking unit may include a stacking process device performing the stacking process; and a separator supply unit supplying a separator to the stacking process device without passing through the transport unit.

In some embodiments of the present disclosure, a battery electrode plate stacking apparatus for engaging with an automatic logistics transport device includes an entry/exit port configured through which a plurality of electrode plate sets sequentially transported by a transporter of a logistics transport device are disposed; a transport unit configured to transport an electrode plate set disposed at the entry/exit port; a stacking unit configured to use a plurality of electrode plates included in the electrode plate set transported by the transport unit in a stacking process; a first door configured to selectively block entry/exit of the transporter into/from the entry/exit port depending on an open/closed state thereof; a second door configured to selectively block manual entry/exit of the electrode plate set depending on the open/closed state; and a device controller configured to communicate with the logistics transport device when set to an automatic mode. The device controller controls an interlock of the second door when set to the automatic mode and controls a release of the interlock of the second door when set to a manual mode.

In an example, the logistics transport device may be configured to sequentially transport the plurality of electrode plate sets according to an Overhead Hoist Transport (OHT) method, and the device controller may communicate with the logistics transport device to enable the transporter to transport the plurality of electrode plate sets, when set to the automatic mode, and may communicate with the logistics transport device to stop the transporter from transporting the plurality of electrode plate sets, when set to the manual mode. When set to the automatic mode, the device controller may receive entry/exit waiting information of the transporter from the logistics transport device, control opening of the first door based on the entry/exit waiting information, transmit opening information of the first door to the logistics transport device, receive farewell waiting information of the transporter from the logistics transport device, and control closing of the first door based on the farewell waiting information.

In an example, each of the plurality of electrode plate sets may further include a loading box in which the plurality of electrode plates are loaded, the transport unit may transport a loading box from which electrode plates have been exhausted by the stacking unit, to the entry/exit port, a transport path of the transport unit may be U-shaped, and an electrode plate set including the plurality of electrode plates and the loading box from which the electrode plates have been exhausted may be disposed in different areas of the entry/exit port.

### BRIEF DESCRIPTION OF DRAWINGS

Certain aspects, features, and advantages of the present disclosure are illustrated by the following detailed description with reference to the accompanying drawings.

FIG. 1 is a block diagram illustrating the control relationship of a battery electrode plate stacking apparatus for engaging with an automatic logistics transport device according to an embodiment.

FIG. 2 is a plan view illustrating a battery electrode plate stacking apparatus for engaging with an automatic logistics transport device according to an embodiment.

FIG. 3 is a side view illustrating an automatic mode of a battery electrode plate stacking apparatus for engaging with an automatic logistics transport device according to an embodiment.

FIG. 4 is a side view illustrating a manual mode of a battery electrode plate stacking apparatus for engaging with an automatic logistics transport device according to an embodiment.

FIG. 5 is a flowchart illustrating a process for transporting an electrode plate set and using the electrode plate in a stacking process in a battery electrode plate stacking apparatus for engaging with an automatic logistics transport device according to an embodiment.

FIG. 6 is a flowchart illustrating a process of discharging an electrode plate-exhausted load box out of the apparatus, in a battery electrode plate stacking apparatus for engaging with an automatic logistics transport device according to an embodiment.

FIGS. 7 to 10 are flowcharts illustrating in more detail a portion of the process of FIG. 5 and/or a portion of the process of FIG. 6.

FIG. 11 is a flowchart illustrating the control of first and second doors in automatic and manual modes of a battery electrode plate stacking apparatus for engaging with an automatic logistics transport device according to an embodiment.

### DETAILED DESCRIPTION

Features of the present disclosure disclosed in this patent document are described by example embodiments with reference to the accompanying drawings.

The following detailed description of the present disclosure refers to the accompanying drawings, which illustrate specific embodiments in which the present disclosure may be practiced. It should be understood that the various embodiments, while different from each other, are not necessarily mutually exclusive. For example, specific shapes, structures, and characteristics described herein may be implemented in other embodiments without departing from the spirit and scope of the present disclosure. Furthermore, it should be understood that the position or disposition of individual components within each disclosed embodiment may be modified without departing from the spirit and scope of the present disclosure. Therefore, the following detailed description is not intended to be limiting, and the scope of the present disclosure, if properly described, is defined only by the appended claims, along with the full scope of equivalents to which such claims are entitled. Like reference numerals in the drawings indicate the same or similar functions throughout.

Hereinafter, embodiments will be described in detail with reference to the accompanying drawings to enable those skilled in the art to readily practice the present disclosure.

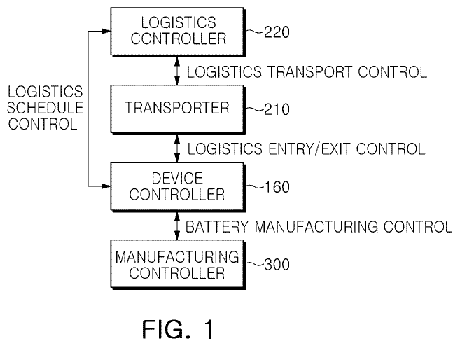

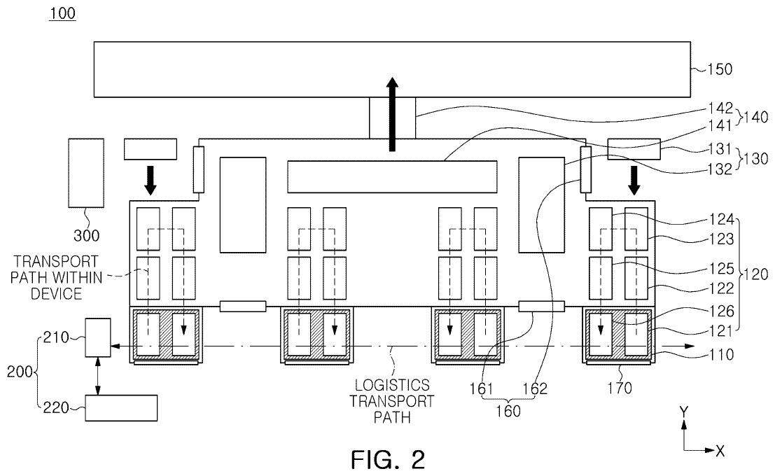

Referring to FIGS. 1 and 2, a logistics transport device 200 may include a transporter 210 that transports logistics (for example, a plurality of electrode plate sets), and a logistics controller 220 that controls the transport of the logistics by the transporter 210, and may be configured to automatically transport the logistics. For example, the logistics transport device 200 may be configured to sequentially transport logistics (for example, a plurality of electrode plate sets) using an Overhead Hoist Transport (OHT) method, but is not limited thereto.

The device controller 160 of the battery electrode plate stacking apparatus 100 for engaging with an automatic logistics transport device may be configured to communicate (for example, wirelessly or wired) with the logistics transport device 200. For example, the device controller 160 may communicate with the logistics controller 220 to control the logistics schedule and with the transporter 210 to control the entry and exit of the logistics. Depending on the design, communication between the device controller 160 and the logistics controller 220 may be via the transporter 210, and communication between the device controller 160 and the transporter 210 may be replaced by communication between the device controller 160 and the logistics controller 220.

A manufacturing controller 300 controls battery manufacturing by controlling various battery processes (for example, an electrode manufacturing process for manufacturing electrode plates, a battery cell assembly process for assembling battery cells including electrode plates, and a formation process for forming electrical properties in the assembled battery cells). The manufacturing controller 300 may communicate with the device controller 160 to control a battery electrode plate stacking apparatus 100 for engaging with an automatic logistics transport device, performing a stacking process, one of the various processes described above. For example, the manufacturing controller 300 may control battery manufacturing according to a manufacturing execution system (MES).

For example, the manufacturing controller 300, device controller 160, and logistics controller 220 may each be implemented as a microcontroller or a computing system. The computing system may include a processing device such as a processor (for example, a CPU, a GPU, an NPU), a storage device such as memory, storage, or a removable storage medium, an input device for receiving information, an output device for outputting information, and a communication device for remotely inputting and outputting information. For example, the storage device may store one or more programs for the processor to execute processing operations. The input device may be implemented as a keyboard, mouse, touch sensor, microphone, or the like, the output device may be implemented as a display panel, speaker, printer, or the like, and the communication device may be implemented as a communication modem, communication circuit, antenna, or the like.

For example, the device controller 160 may be divided into a first device controller 161 and a second device controller 162. Depending on the design, the first and second device controllers 161 and 162 may be integrated into one. For example, the first device controller 161 may control the entry/exit port 110 and the transporter 210, and the second device controller 162 may control the transport unit 120 and the stacking unit 130.

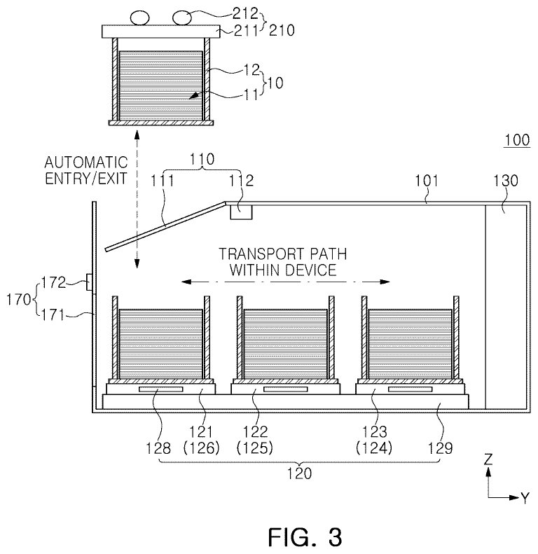

Referring to FIGS. 2 and 3, a battery electrode plate stacking apparatus 100 for engaging with an automatic logistics transport device according to an embodiment may include an entry/exit port 110, a transport unit 120, and a stacking unit 130.

The entry/exit port 110 may be configured such that a plurality of electrode plate sets 10 sequentially transported by the transporter 210 of the logistics transport device 200 are disposed therein. For example, the entry/exit port 110 may be located at the boundary between the space occupied by the battery electrode plate stacking apparatus 100 for engaging with an automatic logistics transport device and the exterior of the space, providing an access path between both sides of the boundary. For example, the boundary may have an exterior formed by a cover member 101, but is not limited thereto.

For example, the transporter 210 may move along a logistics transport path to transport a plurality of electrode plate sets 10 to the entry/exit port 110 one at a time at a predetermined interval (for example, approximately every 20 minutes). Before reaching the entry/exit port 110, the transporter 210 may carry one of the plurality of electrode plate sets 10 and move along a portion of the logistics transport path. A transporter 210 that has reached the entry/exit port 110 may place the electrode plate set 10 in the area 121 of the entry/exit port 110 and then exit the entry/exit port 110 along another part of the logistics transport path.

The transport unit 120 may be configured to transport the electrode plate set 10 disposed at the entry/exit port 110. The transport unit 120 may not belong to the logistics transport device 200 and may not be controlled by the logistics transport device 200. For example, the device controller 160 may control the transport of the transport unit 120.

Due to the transport unit 120, the entry/exit port 110 and the stacking unit 130 may be disposed to be spaced apart from each other at a safe distance or greater, thereby preventing interference (for example, physical collision, introduction of foreign substances into the stacking process) between the automatic logistics transport device of the logistics transport device 200 and the stacking process of the stacking unit 130.

The transport unit 120 may transport the electrode plate set 10 along a transport path within the device. For example, the transport path within the device may transport at least some of the electrode plate sets 10 in the following order: an area 121, a first buffer 122, an area 123, an area 124, a second buffer 125, and an area 126. The transport unit 120 may be implemented as a conveyor belt 129, but is not limited thereto.

The stacking unit 130 may be configured to use a plurality of electrode plates 11 included in the electrode plate set 10 transported by the transport unit 120 for a stacking process. For example, the stacking process may be at least one of winding, stacking, jelly roll, Z-folding, and stack-folding. The stacking unit 130 may stack a plurality of electrode plates 11 of the electrode plate set 10 and a plurality of separators to manufacture a plurality of stacks. The plurality of stacks may be the basis for a plurality of battery cells.

The stacking unit 130 may use a plurality of electrode plates 11 of the electrode plate set 10 disposed in the area 123 of the transport unit 120 for a stacking process, one at a time, at a predetermined cycle. For example, assuming that the transporter 210 transports a plurality of electrode plate sets 10 one at a time every 20 minutes and that the number of electrode plates 11 per electrode plate set 10 is 1,000, the stacking unit 130 may use a plurality of electrode plates 11 for a stacking process, one at a time, at a rate of 1.2 seconds.

The cycle during which the transport unit 120 transports a plurality of electrode plate sets 10 one at a time, and the cycle during which the stacking unit 130 uses a plurality of electrode plates 11 one at a time for the stacking process, may each have deviations (or temporary differences between cycles) due to various factors. For example, these various factors may include, but are not limited to, temporary disruptions in the logistics transport of the transporter 210, cascading schedule adjustments due to temporary disruptions in the battery manufacturing schedule of the manufacturing controller 300, real-time productivity adjustments by the manufacturing controller 300, and the like. Furthermore, the greater the number of battery electrode plate stacking apparatuses 100 for engaging with an automatic logistics transport device, the greater the impact of these various factors on the deviation in cycles.

The deviation in cycles (or temporary differences between cycles) may increase the likelihood that electrode plate sets 10 may be temporarily unable to be disposed in area 123. If the electrode plate set 10 is not temporarily disposed in the area 123, the stacking unit 130 may be temporarily unable to perform the stacking process, resulting in a decrease in battery manufacturing productivity.

The transport unit 120 may include a first buffer 122 that places the next electrode plate set 10 on standby thereon when a plurality of electrode plates 11 of the electrode plate set 10 priorly transported to the stacking unit 130 among the plurality of electrode plate sets 10 are being used in the stacking process. Accordingly, even if there is a deviation (or a temporary difference between the cycles) between the cycle in which the transport unit 120 transports the plurality of electrode plate sets 10 one by one and the cycle in which the stacking unit 130 uses the plurality of electrode plates 11 one by one in the stacking process, the temporary failure to dispose the electrode plate set 10 in area 123 may be prevented. Therefore, the productivity of the stacking process may be improved.

Each of the plurality of electrode plate sets 10 may further include a loading box 12 into which a plurality of electrode plates 11 are loaded. For example, the loading box 12 may have side surfaces surrounding the plurality of electrode plates 11 and a lower surface supporting the plurality of electrode plates 11. The stacking unit 130 may pick up the plurality of electrode plates 11 one by one from the upper side of the loading box 12. The loading box 12 may be expressed as a magazine, but is not limited thereto.

The transport unit 120 may transport the loading box 12 from which the electrode plates 11 have been exhausted by the stacking unit 130 to the entry/exit port 110. Accordingly, since the logistics transport path of the transporter 210 may be used jointly for transporting the electrode plate set 10 and picking up the loading box 12, the automatic logistics transport device efficiency of the logistics transport device 200 may be improved.

For example, when all electrode plates 11 of the electrode plate set 10 disposed in area 123 are exhausted, the transport unit 120 may transport the loading box 12 from which electrode plates 11 have been exhausted to area 124 and then transport the next electrode plate set 10 to area 123. Depending on the design, areas 123 and 124 may be combined into a single area. Thereafter, the transport unit 120 may transport the loading box 12 disposed in area 124 to area 126 of the entry/exit port 110. The transporter 210 may pick up a loading box 12 disposed in the area 126. The cycle at which the transporter 210 picks up a plurality of loading boxes 12 one at a time may be set to the same cycle at which it transports multiple electrode plate sets 10 one at a time.

The transport unit 120 may further include a second buffer 125 that places the next loading box 12 on standby thereon when a loading box 12 with exhausted electrode plates 11 is disposed at the entry/exit port 110. Accordingly, the waiting time for the transporter 210 to pick up a loading box 12 may be reduced, and the degree of freedom of overlap between the transport schedule for multiple electrode plate sets 10 and the pickup schedule for multiple loading boxes 12 may be improved, thereby improving the efficiency of picking up the loading box 12.

For example, the first buffer 122 and the second buffer 125 may have substantially symmetrical (or complementary) shapes. For example, the number of electrode plate sets 10 that may be disposed in the first buffer 122 may be one or more, and a plurality of electrode plate sets 10 in awaiting may be arranged in a single row along a transport path within the device. For example, the number of loading boxes 12 that may be disposed in the second buffer 125 may be one or more, and a plurality of loading boxes 12 in awaiting may be arranged in a single row along a transport path within the device.

The transport path (transport path within the device) of the transport unit 120 includes a U-turn path, and an electrode plate set 10 including a plurality of electrode plates 11 and a loading box 12 from which electrode plates 11 have been exhausted may be disposed in different areas 121 and 126 in the entry/exit port 110. For example, the U-turn path may be a path in which the transport direction bends twice by an angle of about 90 degrees, or a path in which the transport direction rotates by an angle of about 180 degrees. For example, the U-turn path may be implemented by a turn table located in areas 123 and 124 of the transport unit 120. Both ends of the U-turn path may correspond to different areas 121 and 126 in the entry/exit port 110. The size/shape of the areas 121 and 126 may be determined based on the size/shape of the loading box 112, and the area 121 may be configured (for example, by disposing an elastic member for shock absorption, forming an outer frame to prevent sideways slipping, or the like) so that a plurality of electrode plate sets 10 may be stably seated.

The entry/exit port 110 is a plurality of entry/exit ports 110, the first buffer 122 is a plurality of first buffers 122 on which the electrode plate sets 10 respectively disposed in the entry/exit ports 110 wait before being transported to the stacking unit 130, and the second buffer 125 is a plurality of second buffers 125 on which the plurality of loading boxes 12 that have exhausted their electrode plates 11 wait before being respectively transported to the entry/exit ports 110. The plurality of entry/exit ports 110 may be arranged in a direction (for example, X-direction) in which the disposing positions at both ends of the U-turn path of the transport path of the transport unit 120 face each other.

For example, one entry/exit port 110, one first buffer 122, and one second buffer 125 may form one transport set, and the battery electrode plate stacking apparatus 100 for engaging with an automatic logistics transport device may include multiple transport sets. The arranging direction (for example, X-direction) of the plurality of entry/exit ports 110 may be the same as the extending direction (for example, X-direction) of the logistics transport path of the transporter 210. For example, the transporter 210 may include multiple carriers 211 arranged along the logistics transport path, and the multiple carriers 211 may move along rails 212 extended along the logistics transport path. For example, an electrode plate 11 transported through some of the plurality of entry/exit ports 110 may be a cathode plate, and an electrode plate 11 transported through the remaining ports among the plurality of entry/exit ports 110 may be an anode plate.

Referring to FIG. 2, the stacking unit 130 may include a stacking process device 132 that performs the stacking process, and a separator supply unit 131 that provides a separator to the stacking process device 132 without going through the transport unit 120. Accordingly, confusion between providing a plurality of electrode plates 11 to the stacking process device 132 and providing a separator may be prevented. For example, the plurality of entry/exit ports 110 and the separator supply unit 131 may be disposed on one side (for example, the −Y-direction edge) and the other side (for example, the +Y-direction edge) of a battery electrode plate stacking apparatus 100 for engaging with an automatic logistics transport device, respectively. Compared to the plurality of entry/exit ports 110, the separator supply unit 131 may be disposed closer to the stacking process device 132, and the separator may not be transported by the transport unit 120.

The stacking process device 132 of the stacking unit 130 may manufacture a stack in which a separator is stacked between a cathode plate and an anode plate among a plurality of electrode plates 11, at a predetermined cycle rate, and transport the plurality of stacks to post-processing equipment 150 via the post-processing transport unit 140.

For example, the first part 141 of the post-process transport unit 140 may transport multiple stacks to a predetermined location, and the second part 142 of the post-process transport unit 140 may transport the multiple stacks from the predetermined location to the post-processing equipment 150. The post-process transport unit 140 may be implemented as a conveyor belt, but is not limited thereto.

For example, the post-processing equipment 150 may perform a process of disposing the stack and electrolyte within a battery case or a process of welding electrode plates, and may manufacture multiple battery cells from the multiple stacks. For example, the multiple battery cells may be pouch-shaped, cylindrical, or prismatic, but is not limited thereto.

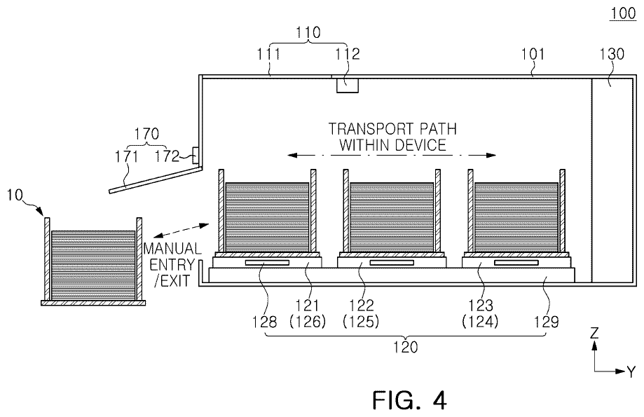

Referring to FIGS. 3 and 4, the battery electrode plate stacking apparatus 100 for engaging with an automatic logistics transport device may further include at least one of a first door 111 configured to selectively block entry/exit of the transporter 210 to the entry/exit port 110 depending on the open/closed state, and a second door 171 configured to selectively block manual entry/exit of the electrode plate set 10 depending on the open/closed state.

For example, the cover member 101 may accommodate the transport unit 120, the stacking unit 130 and the post-process transport unit 140 together, and may have areas in which the first and second doors 111 and 171 are disposed and which are respectively open. The first and second doors 111 and 171 may selectively block the open areas of the cover member 101 depending on the open/closed state.

The first door 111 may be in an open state when the transporter 210 enters and exits. The first door 111 may be in a closed state when the transporter 210 does not enter and exit, and may block foreign substances (for example, dust, moisture) from entering through the entry/exit port 110. Accordingly, the battery electrode plate stacking apparatus 100 for engaging with an automatic logistics transport device may receive a plurality of electrode plates 11 in conjunction with the automatic logistics transport device, while preventing interference (for example, foreign substances from entering the stacking process) caused by the automatic logistics transport device interlocking with the stacking process of the stacking unit 130. When the logistics transport device 200 is of the OHT type, the first door 111 may be an upper door of the battery electrode plate stacking apparatus 100 for engaging with an automatic logistics transport device and may overlap with areas 121 and 126 of the transport unit 120 in the Z-direction.

The second door 171 may be open when the electrode plate set 10 enters or exits. The second door 171 may be closed when the electrode plate set 10 does not enter or exit. The second door 171 may be one door of a battery electrode plate stacking apparatus 100 for engaging with an automatic logistics transport device and may be spaced apart from the first door 111 so as not to interfere with the opening and closing operation of the first door 111.

Depending on the design, the first door 111 may be included in the entry/exit port 110, and the entry/exit port 110 may further include a first door actuator 112. The second door 171 may be included in the manual entry/exit port 170, and the manual entry/exit port 170 may further include a second door actuator 172. The first and second door actuators 112 and 172 may respectively communicate with a device controller (160 of FIG. 2), receive control signals from the device controller (160 of FIG. 2), and provide driving force for opening and closing the first and second doors 111 and 171 according to the control signals. For example, the first and second doors 111 and 171 may be implemented as an integrated circuit and a printed circuit board, respectively, but are not limited thereto.

Referring to FIGS. 3 and 4, the transport unit 120 may include a placement sensor 128 configured to sense the presence of a plurality of electrode plate sets 10 at the entry/exit port 110 and transmit the sensing information to the device controller 160. For example, the placement sensor 128 may include a photo sensor or a load cell sensor. The placement sensor 128 may sense the disposition of a plurality of electrode plate sets 10 onto the transport unit 120 by sensing a decrease in the light reception value of the photo sensor or an increase in pressure of the load cell sensor. The placement sensor 128 may communicate with the device controller 160 of FIG. 2 and transmit sensing information of the placement sensor 128 to the device controller 160 of FIG. 2.

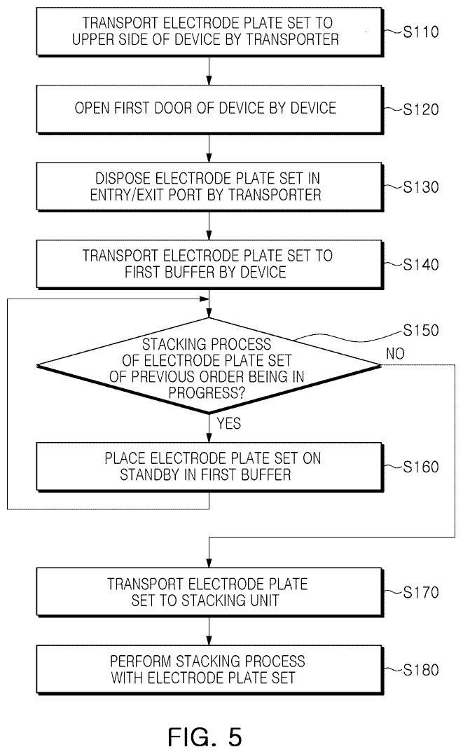

Referring to FIGS. 2, 3, and 5, when the transporter 210 transports the electrode plate set 10 to the upper side of the device (S110), the device controller 160 may control the device to open the first door 111 (S120). For example, the device controller 160 may receive entry/exit waiting information of the transporter 210 from the logistics transport device 200, control the opening of the first door 111 according to the entry/exit waiting information, and transmit the opening information of the first door 111 to the logistics transport device 200. Accordingly, the consistency between the time when the first door 111 is open and the time when the transporter 210 enters/exits the entry/exit port 110 may be improved, so that the introduction of foreign substances due to the first door 111 being unnecessarily opened may be prevented.

Thereafter, when the transporter 210 disposes the electrode plate set 10 in the area 121 of the entry/exit port 110 (S130), the transport unit 120 of the device may transport the electrode plate set 10 to the first buffer 122 (S140). Thereafter, the transport unit 120 checks whether the stacking process of the electrode plate set 10 of the previous order is in progress (S150), and if the stacking process is in progress, the electrode plate set 10 is placed on standby in the first buffer 122 (S160), and if the stacking process is not in progress, the electrode plate set 10 may be transported to the area 123 of the stacking unit 130 (S170), and the stacking unit 130 may perform the stacking process with the electrode plate set 10 (S180).

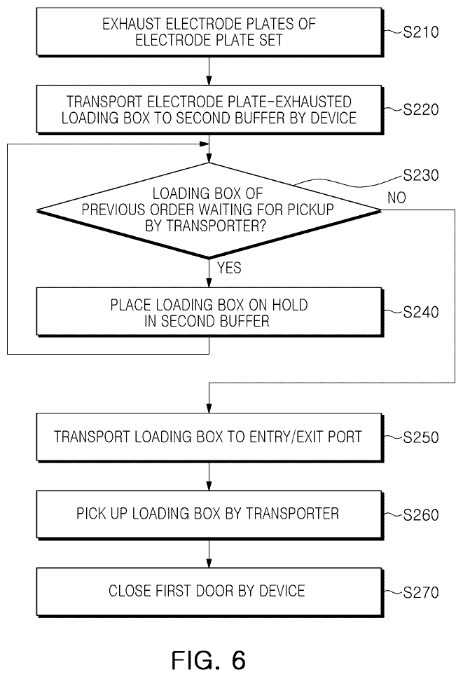

Referring to FIGS. 2, 3, and 6, when the stacking unit 130 exhausts the electrode plates 11 of the electrode plate set 10 (S210), the transport unit 120 of the device may transport the electrode plate-exhausted loading box 12 to the second buffer 125 (S220). Thereafter, the transport unit 120 may check whether the loading box 12 of the previous order is waiting to be picked up by the transporter 210 (S230), and if it is waiting for pickup, the loading box 12 may be placed on hold in the second buffer 125 (S240), and if it is not waiting for pickup, the transport unit 120 may transport the loading box 12 to the area 126 of the entry/exit port 110 (S250). Thereafter, the transporter 210 picks up the loading box 12 (S260), and the device controller 160 may control the device to close the first door 111 (S270). For example, the device controller 160 may receive farewell waiting information for the transporter 210 from the logistics transport device 200 and control the closing of the first door 111 based on the farewell waiting information. Accordingly, the consistency between the time the first door 111 is open and the time the transporter 210 enters and exits the entry/exit port 110 may be improved, thereby preventing the inflow of foreign substances due to the first door 111 being unnecessarily opened.

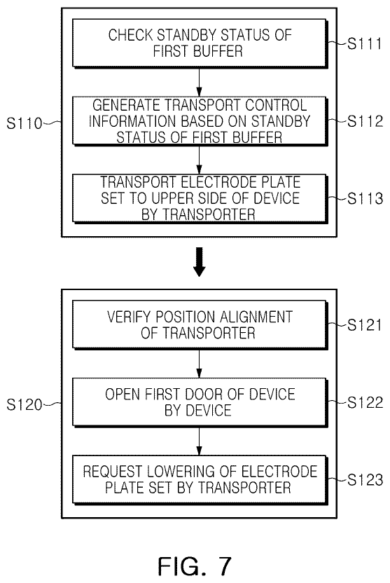

Referring to FIGS. 2, 3, and 7, the device controller 160 of the device may check the standby status (for example, the number of electrode plate sets 10 on standby and/or standby time) of the first buffer 122 (S111), generate transport control information based on the standby status of the first buffer 122 (S112), and transmit the transport control information to the logistics transport device 200. The logistics controller 220 of the logistics transport device 200 may control the transporter 210 to transport the electrode plate set 10 to the upper side of the device (S113) according to the transport control information.

Thereafter, the device controller 160 of the device may verify the position alignment of the transporter 210 (for example, alignment between the XY coordinates of the center of the transporter 210 and the XY coordinates of the center of the first door 111) (S121), control the opening of the first door 111 (S122), and request the transporter 210 to lower the electrode plate set 10 (S123).

For example, the device controller 160 may communicate with the transporter 210 to control entry and exit to the entry/exit port 110 of the transporter 210. Compared to the possibility of a communication failure between the device controller 160 and a logistics controller 220 located further away from the transporter 210, the possibility of a direct communication failure between the transporter 210 and the device controller 160 may be lower. Accordingly, the device controller 160 may safely control the position alignment and/or the elevation of the transporter 210 by reducing the possibility of communication interruption during the position alignment control/feedback and/or the elevation control/feedback process of the transporter 210. For example, the transporter 210 may include a terminal for short-range wireless communication with the device controller 160, and may further include an actuator that processes the transmission/reception signals of the terminal to drive the movement and/or elevation of the device controller 160.

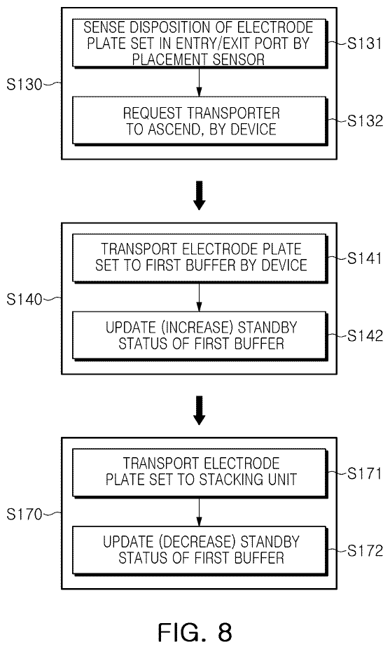

Referring to FIGS. 2, 3, and 8, the placement sensor 128 may sense the disposition of the electrode plate set 10 in the entry/exit port 110 (S131). The device controller 160 of the device may request the transporter 210 to ascend (S132) to control the transporter 210 to stop descending or to ascend based on the sensing information of the placement sensor 128, may transport the electrode plate set 10 to the first buffer 122 (S141), and update (increase) the standby status of the first buffer 122 (S142). Thereafter, the device controller 160 of the device may transport the electrode plate set 10 to the stacking unit 130 (S171) and update (decrease) the standby status of the first buffer 122 (S172).

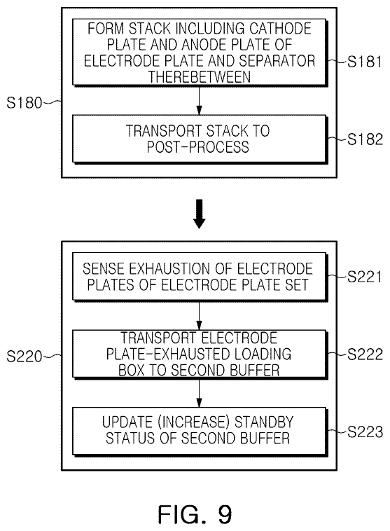

Referring to FIGS. 2, 3, and 9, the stacking unit 130 may form a stack including the cathode plate and anode plate of the electrode plate 11 and a separator therebetween (S181), and transport the stack to a post-process (S182). Thereafter, the device controller 160 and/or the placement sensor 128 may sense the exhaustion of the electrode plates 11 of the electrode plate set 10 (S221), and the device controller 160 of the device may transport the electrode plate(11)—exhausted loading box 12 to the second buffer 125 (S222), and update (increase) the standby status of the second buffer 125 (S223).

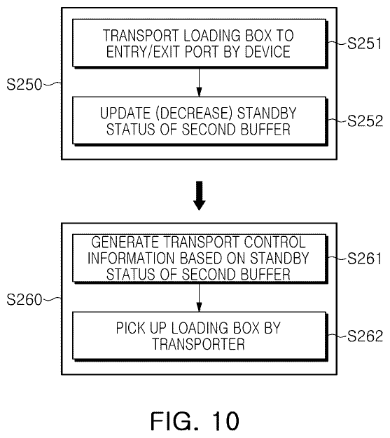

Referring to FIGS. 2, 3 and 10, the device controller 160 of the device may transport the loading box 12 to the entry/exit port 110 (S251), update (decrease) the standby status of the second buffer (S252), generate transport control information based on the standby status of the second buffer 125 (S261), and transmit the transport control information to the logistics transport device 200. The logistics controller 220 of the logistics transport device 200 may control the transporter 210 to pick up the loading box 12 (S262) according to the transport control information.

For example, the device controller 160 may generate transporter request information based on at least one of the electrode plate set standby status of the first buffer 122 and the loading box standby status of the second buffer 125, and transmit the transporter request information to the logistics transport device 200. Accordingly, excessive accumulation of electrode plate set standby status in the first buffer 122 or excessive accumulation of loading box standby status in the second buffer 125 may be prevented. Consequently, the productivity of the stacking process may be stably improved.

For example, the device controller 160 may transmit information on the number of electrode plate sets waiting in the first buffer 122 and/or total waiting time information to the logistics controller 220, and may transmit information on the number of loading boxes waiting in the second buffer 125 and/or total waiting time information to the logistics controller 220. The logistics controller 220 compares the number information and/or the total waiting time information with a reference value, and if the number or the total waiting time is greater than the reference value, the transport cycle of the transporter 210 may be reduced or emergency transport of the transporter 210 may be controlled.

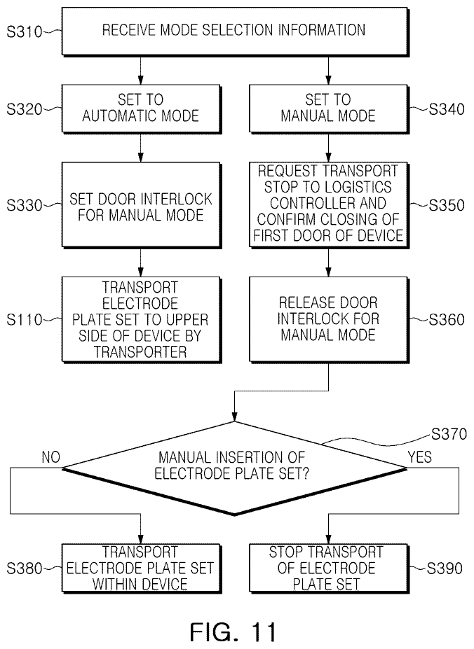

Referring to FIGS. 2, 3, and 11, the device controller 160 may receive mode selection information (S310), control the interlock of the second door 171 when set to automatic mode (S320), to set a door interlock for manual mode (S330), and may communicate with the logistics transport device 200 to have the transporter 210 transport the electrode plate set 10 to the upper side of the first door 111 of the device (S110).

When set to manual mode (S340), the device controller 160 may communicate with the logistics transport device 200 to enable the transporter 210 to stop transporting a plurality of electrode plate sets 10 and confirm the closure of the first door 111 of the device (S350), and may control the release of the interlock of the second door 171 (S360).

By selectively interlocking the first door 111, the interoperability of automatic logistics transport device may be secured, while safety (for example, preventing collisions between the transporter and the operator) may be improved when the operator manually inserts the electrode plate set 10.

Thereafter, the transport unit 120 may control the transport of the electrode plate set 10 within the device (S380) if there is no manual insertion of the electrode plate set 10 (S370), and may stop the transport of the electrode plate set 10 (S390) if there is manual insertion of the electrode plate set 10 (S370).

As set forth above, in a battery electrode plate stacking apparatus for engaging with an automatic logistics transport device according to an embodiment, the productivity and/or safety of a stacking process may be improved by stably engaging an automatic logistics transport device.

Only specific examples of implementations of certain embodiments are described. Variations, improvements and enhancements of the disclosed embodiments and other embodiments may be made based on the disclosure of this patent document.

What is claimed is:

1. A battery electrode plate stacking apparatus for engaging with an automatic logistics transport device, comprising:
an entry/exit port configured through which a plurality of electrode plate sets sequentially transported by a transporter of a logistics transport device are disposed;
a transport unit configured to transport an electrode plate set disposed at the entry/exit port; and
a stacking unit configured to use a plurality of electrode plates included in the electrode plate set transported by the transport unit in a stacking process,
wherein the transport unit includes a first buffer on which a next-order electrode plate set waits when a plurality of electrode plates of an electrode plate set priorly transported to the stacking unit among the plurality of electrode plate sets are being used in the stacking process.

2. The battery electrode plate stacking apparatus of claim 1, wherein each of the plurality of electrode plate sets further includes a loading box into which a plurality of electrode plates are loaded, and
the transport unit transports a loading box from which electrode plates have been exhausted by the stacking unit, to the entry/exit port.

3. The battery electrode plate stacking apparatus of claim 2, wherein the transport unit further includes a second buffer on which a next loading box waits when a loading box, from which the electrode plates have been exhausted, is disposed at the entry/exit port.

4. The battery electrode plate stacking apparatus of claim 3, wherein a transport path of the transport unit includes a U-turn path, and
an electrode plate set including the plurality of electrode plates, and a loading box from which the electrode plates have been exhausted, are disposed in different areas of the entry/exit port.

5. The battery electrode plate stacking apparatus of claim 4, wherein the entry/exit port is provided as a plurality of entry/exit ports,
the first buffer is provided as a plurality of first buffers on which electrode plate sets disposed in the plurality of entry/exit ports, respectively, wait before being transported to the stacking unit, and
the second buffer is provided as a plurality of second buffers on which a plurality of loading boxes from which respective electrode plates have been exhausted wait before being respectively transported to the plurality of entry/exit ports.

6. The battery electrode plate stacking apparatus of claim 5, further comprising a device controller configured to communicate with the logistics transport device,
wherein the device controller generates transporter request information based on at least one of an electrode plate set standby status of the first buffer and a loading box standby status of the second buffer, and transmits the transporter request information to the logistics transport device.

7. The battery electrode plate stacking apparatus of claim 1, wherein the entry/exit port is provided as a plurality of entry/exit ports, and
the first buffer is provided as a plurality of first buffers on which electrode plate sets respectively disposed in the plurality of entry/exit ports wait before being transported to the stacking unit.

8. The battery electrode plate stacking apparatus of claim 1, further comprising a device controller configured to communicate with the logistics transport device,
wherein the device controller generates transporter request information based on an electrode plate set standby status of the first buffer and transmits the transporter request information to the logistics transport device.

9. The battery electrode plate stacking apparatus of claim 1, further comprising:
a first door configured to selectively block the transporter from entering or exiting the entry/exit port depending on an open/closed state of the first door; and
a device controller configured to communicate with the logistics transport device,
wherein the device controller receives entry/exit waiting information of the transporter from the logistics transport device, controls opening of the first door based on the entry/exit waiting information, transmits opening information of the first door to the logistics transport device, receives farewell waiting information of the transporter from the logistics transport device, and controls closing of the first door based on the farewell waiting information.

10. The battery electrode plate stacking apparatus of claim 9, wherein the logistics transport device is configured to sequentially transport the plurality of electrode plate sets using an Overhead Hoist Transport (OHT) method, and
the logistics transport device includes a logistics controller and the transporter,
wherein the logistics controller controls a logistics transport of the transporter, and
the device controller communicates with the transporter and controls entry/exit of the transporter through the entry/exit port.

11. The battery electrode plate stacking apparatus of

10. wherein the transport unit includes a placement sensor configured to sense that the plurality of electrode plate sets are disposed at the entry/exit port and to transmit sensing information to the device controller, and
the device controller controls a descent stop or an ascent of the transporter based on the sensing information from the placement sensor.

12. The battery electrode plate stacking apparatus of claim 9, further comprising:
a second door configured to selectively block manual entry/exit of an electrode plate set depending on an open/closed state of the second door, and
a device controller configured to communicate with the logistics transport device when set to an automatic mode,
wherein the device controller controls an interlock of the second door when set to the automatic mode, and controls a release of the interlock of the second door when set to a manual mode.

13. The battery electrode plate stacking apparatus of claim 12, wherein the device controller communicates with the logistics transport device to enable the transporter to transport the plurality of electrode plate sets, when set to the automatic mode, and communicates with the logistics transport device to stop the transporter from transporting the plurality of electrode plate sets, when set to the manual mode.

14. The battery electrode plate stacking apparatus of claim 1, wherein the stacking unit includes,
a stacking process device performing the stacking process; and
a separator supply unit supplying a separator to the stacking process device without passing through the transport unit.

15. A battery electrode plate stacking apparatus for engaging with an automatic logistics transport device, comprising:
an entry/exit port configured through which a plurality of electrode plate sets sequentially transported by a transporter of a logistics transport device are disposed;
a transport unit configured to transport an electrode plate set disposed at the entry/exit port;
a stacking unit configured to use a plurality of electrode plates included in the electrode plate set transported by the transport unit in a stacking process;
a first door configured to selectively block entry/exit of the transporter into/from the entry/exit port depending on an open/closed state of the first door;
a second door configured to selectively block manual entry/exit of an electrode plate set depending on the open/closed state of the second door; and
a device controller configured to communicate with the logistics transport device when set to an automatic mode,
wherein the device controller controls an interlock of the second door when set to the automatic mode and controls a release of the interlock of the second door when set to a manual mode.

16. The battery electrode plate stacking apparatus of claim 15, wherein the logistics transport device is configured to sequentially transport the plurality of electrode plate sets according to an Overhead Hoist Transport (OHT) method, and
the device controller communicates with the logistics transport device to enable the transporter to transport the plurality of electrode plate sets, when set to the automatic mode, and communicates with the logistics transport device to stop the transporter from transporting the plurality of electrode plate sets, when set to the manual mode,
when set to the automatic mode, the device controller receives entry/exit waiting information of the transporter from the logistics transport device, controls opening of the first door based on the entry/exit waiting information, transmits opening information of the first door to the logistics transport device, receives farewell waiting information of the transporter from the logistics transport device, and controls closing of the first door based on the farewell waiting information.

17. The battery electrode plate stacking apparatus of claim 15, wherein each of the plurality of electrode plate sets further includes a loading box in which a plurality of electrode plates are loaded,
the transport unit transports a loading box from which electrode plates have been exhausted by the stacking unit, to the entry/exit port,
a transport path of the transport unit is U-shaped, and
an electrode plate set including the plurality of electrode plates and a loading box from which the electrode plates have been exhausted are disposed in different areas of the entry/exit port.
